(19) United States
(12) Patent Application Publication
(10) Pub. No.: US 2015/0165632 A1
(43) Pub. Date: Jun. 18, 2015

(54) STACK CUTTER

(71) Applicant: PLUS CORPORATION, TOKYO (JP)

(72) Inventors: Ryo Yasui, Tokyo (JP); Tetsuya Imai, Tokyo (JP)

(21) Appl. No.: 14/558,670

(22) Filed: Dec. 2, 2014

(30) Foreign Application Priority Data
Dec. 13, 2013 (JP) JP2013257580

(51) Int. Cl. B26D 1/08; B26D 7/22

(52) U.S. Cl. CPC B26D 1/085; B26D 7/22

(57) ABSTRACT

The present invention provides a stack cutter that is capable of providing safe cutting of object to be cut, such as multiple sheets of paper or resin films, and that can be stored in a small space.

In the present invention, a cutting base 2 of a stack cutter on which object are placed can be folded into a body case 3 to cover an insert opening 10 in the body case 3.

### CLAIM OF PRIORITY TO RELATED APPLICATION

The application claims priority from Japanese Patent Application No. 2013-257580 filed Dec. 13, 2013, the disclosure of which is incorporated herein by reference in its entirety.

### BACKGROUND OF THE INVENTION

1. Technical field

The present invention relates to a stack cutter.

2. Background art

When it is necessary to cut object such as multiple sheets of paper or layers of resin films stacked on top of each other, a stack cutter is used for precise and rapid cutting of them.

Stack cutters that have been used for the longest time are guillotine cutters with a long blade hinged to an edge of a cutting base at one end of the blade. A user holds a handle provided at the other end of the blade and brings the blade down in pivotal motion toward the cutting base to cut through the object placed on the cutting base.

Different types of stack cutters have then been proposed and practically used. Examples include stack cutters with a blade that is brought down while extending in generally parallel to the cutting base to cut through the object placed on the cutting base. Other examples are rotary trimmers with a cutting base, a straight guide member placed on the cutting base, and a blade that is held perpendicular to the cutting base and can rotate and move along a straight path as guided by the guide member. A user slides the rotating blade horizontally along the guide member to trim the object placed on the cutting base.

The aforementioned stack cutters have the cutting base in common. Cutting bases are typically large and heavy because they are provided to allow cutting of the object held thereon, which makes stack cutters inconvenient to handle. In addition, such stack cutters require a large space to store when not in use.

An object of the present invention is to provide a stack cutter that is easy to handle and can be stored in a smaller space when not in use.

### BRIEF SUMMARY OF THE INVENTION

In order to solve the aforementioned problems, the present inventor provides a stack cutter comprising a body case having an insert opening formed in one end of the body case through which an object to be cut is inserted into the body case, and an exit opening formed in the other end of the body case through which the object comes out, the body case comprising a cutting portion with a mounting surface on which the object is cut, with its leading edge sticking out of the exit opening and its trailing edge being left without being inserted into the body case; a blade adapted to move vertically relative to the mounting surface provided on the body case to cut the object; operating means for use in moving the blade up and down; and a cutting base surface that can be flushed with the mounting surface. The cutting base of this stack cutter is designed to be in a first position in which the cutting base surface is flush with the mounting surface and a second position in which the cutting base is folded against the body case in such a manner that the cutting base covers the insert opening.

The cutting base of this stack cutter is, as described above, designed to be in a first position in which the cutting base surface is flush with the mounting surface and a second position in which the cutting base is folded against the body case in such a manner that the cutting base covers the insert opening. The cutting base can be rest in the second position when the stack cutter is not in use. The cutting base in the first position is in horizontal orientation, while the cutting base in the second position is in, for example, vertical orientation. As a result, the stack cutter can be stored in a smaller space and can be handled more easily when not in use by holding the cutting base of the stack cutter in vertical orientation when not in use.

In addition, the cutting base covers the insert opening when it is in the second position. The insert opening is intended to be used to insert the object to be cut into the body case, but could create a risk such that a child inserts his or her finger into it. Such a risk can be avoided almost completely by covering the insert opening in the body case with the cutting base when the stack cutter is not in use.

The cutting base may be housed in the body case when it is in the second position.

This encases the cutting base into the body case like a single unit. As a result, the stack cutter can be stored in a smaller space and can be handled more easily when not in use.

The stack cutter of the present application may comprise a light emitting unit that projects a linear light beam onto the cutting portion to allow a user to visually confirm a cut line identifying the cut position on the object placed on the cutting portion. In such a case, the light emitting unit may be controlled to be turned off when the cutting base comes to the second position.

As described above, it is convenient that the user can intuitively confirm the cut line identifying the cut position on the object with the help of the light emitting unit. The light emitting unit, if present, should be turned off when the stack cutter is not in use. Of course, the stack cutter may have a switch with which the user can manually turn on and off the light emitting unit. The user can, however, possibly forget to manipulate the switch to turn off the light emitting unit when he or she finishes the use of the stack cutter. On the other hand, the light emitting unit is automatically turned off when the user moves the cutting base into the second position to finish the use of the stack cutter if the light emitting unit is controlled to be turned off in response to the cutting base coming into the second position. The light emitting unit is not likely to be left turned on after the use of the stack cutter is completed.

In the stack cutter of the present application, a protective cover is provided over on, or in the exit opening to close the exit opening, the protective cover being designed to open the exit opening by the object inserted through the insert opening. The protective cover may be designed not to open the exit opening when a user attempts to insert the object through the exit opening.

The presence of the protective cover contributes to avoiding unexpected situations, for example, where a young child inserts his or her finger into the exit opening.

A tapered section may be provided above the insert opening of the present application, the tapered section being tapered inwardly toward the insert opening. For example, with the body case having the aforementioned tapered section, the object can be introduced into the insert opening without any trouble even if the advancing edges of the object such as stacks of paper are slightly warped up.

A guide member may be provided on the cutting base of the stack cutter according to the present invention, the guide member being able to be positioned relative to the body case when the cutting base is in the first position, the guide member being used to set the side of the object against to position the object.

The guide member facilitates the user to adjust the position of the object relative to the cut position along which the blade cuts through the object.

The operating means of the stack cutter according to the present invention may be a stick-shaped arm, and the body case may be configured to house the arm. In such a case, the body case may have an arm locking member to fix the arm when the arm is housed in the body case.

With the arm locking member, the arm that serves as the operating means can be kept within the stack cutter when the stack cutter is not in use. This provides easier handling of the stack cutter when not in use.

### BRIEF DESCRIPTION OF THE DRAWINGS

FIG. 1 is a perspective view showing a structure of a stack cutter according to an embodiment of the present invention;

FIG. 2 is a perspective view showing the stack cutter in FIG. 1 with a cutting base folded up;

FIG. 3 is a cross-sectional view used to describe a structure of a blade assembly of the stack cutter in FIG. 1;

FIG. 4 is a top plan view of the cutting base and a guide member of the stack cutter in FIG. 1;

FIG. 5 is a perspective view of an arm of the stack cutter in FIG. 1, with the arm in a locked state;

FIG. 6 is a view showing a link mechanism of the stack cutter in FIG. 1;

FIG. 7 is a view that schematically shows the motion of a blade of the stack cutter; and

FIG. 8 is a perspective view of a modified version of the stack cutter.

### DETAILED DESCRIPTION OF THE INVENTION

A preferred embodiment of the present invention is described in detail below with reference to the drawings.

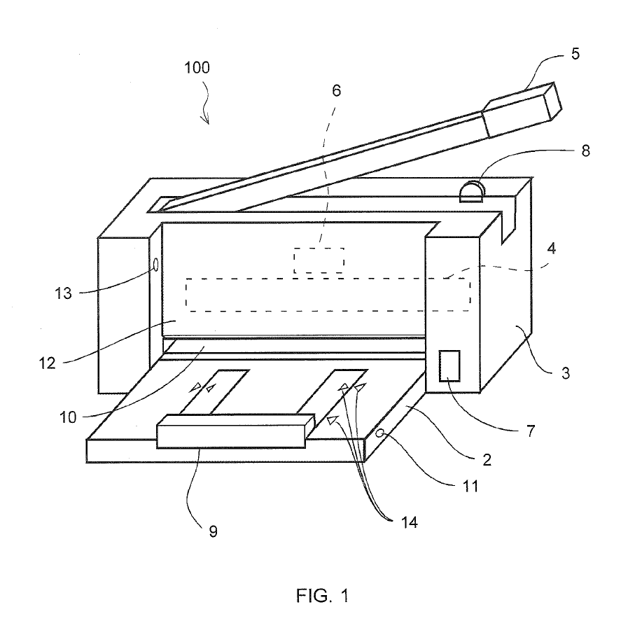

FIG. 1 is a perspective view of a stack cutter 100 according to this embodiment.

The stack cutter 100 comprises a cutting base 2 on which object such as a sheet of paper or a resin film to be cut are held or placed, and a body case 3 provided at one end of the cutting base 2.

The body case 3 contains a link mechanism described below, a blade assembly 4 including a blade described later, and a light emitting unit 6 for projecting a light beam onto the topmost of the object. The light beam provides a cutting line along which the object are cut when the blade is brought down. The light emitting unit 6 is configured with, but not limited to, an LED, a slit through which the light beam from the LED is emitted as a linear beam, and a lens that provide an image by the light beam from the slit onto the topmost of the object. A user can cut the object easily and precisely while seeing the light beam produced by the light emitting unit 6.

An arm 5, a switch 7, a locking member 8, and a guide member 9 are attached to the body case 3. The arm 5 is used by the user to move the blade assembly 4 up and down. The switch 7 is for turning on and off the light emitting unit 6. The locking member 8 is used to lock the arm 5 with the arm 5 housed in the body case 3. The guide member 9 can be slid from a position at the other end of the cutting base 2.

The proximal end of the arm 5 is housed within the body case 3.

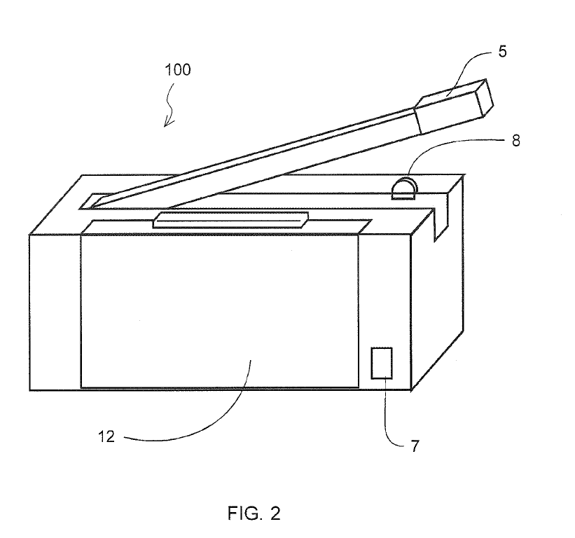

As shown in FIG. 2, the cutting base 2 can be fitted into a cutting base recess 12 that is formed in the outer surface of the body case 3. The cutting base recess 12 has a shape corresponding to the contour of the cutting base 2.

In order to ensure this storage, lugs or projections 11 are provided on both sides of the cutting base 2. In addition, bores 13 are formed in the side surfaces of the cutting base recess 12 in the body case 3 at the positions corresponding to the projections 11. When the cutting base 2 is received in the cutting base recess 12, the projections 11 engage with the respective bores 13. This results in temporal holding of the cutting base 2 in the body case 3.

In general, the stack cutter 100 before and after its use is in the state shown in FIG. 2 where the cutting base 2 is received in the body case 3.

After the use of the stack cutter 100 is completed, the switch 7 is manipulated to turn off the light emitting unit 6 and make the light beam providing the cutting line disappear. The cutting base 2 is then folded up into the body case 3.

Conventional stack cutters take up a large storage space after their use. In contrast, in the stack cutter 100 according to this embodiment, the cutting base 2 can be folded up vertically which otherwise takes up a large space for horizontal placement. This allows compact storage of the stack cutter 100.

When received in the body case 3, the cutting base 2 covers and hides an insert opening 10 formed in the body case 3. The insert opening 10 is to allow a user to insert the object to be cut into the body case 3 (i.e., underneath a blade described later). The stack cutter 100 has excellent safety because the insert opening 10 is covered and hidden with the cutting base 2 when the stack cutter 100 is not in use. This reduces the risk of, for example, causing an unexpected injury to fingers of a child inserted unknowingly into the insert opening 10.

While not illustrated in the figure, another switch is provided within the body case 3. This switch is turned on and off depending on the position of the cutting base 2. More specifically, this switch is designed to turn off the light emitting unit 6 when the cutting base 2 is received in the body case 3. As described above, the light emitting unit 6 is usually turned on and off by the switch 7. With the additional switch operated according to the position of the cutting base 2, however, the light emitting unit 6 in the stack cutter 100 is automatically turned off just in response to the fitting of the cutting base 2 into the body case 3 even if the user forgets to turn off the switch 7 after he or she is done with the stack cutter 100. It is thus possible to avoid leaving the light emitting unit 6 turned on even if the user forgets to operate the switch 7 after he or she is done with the stack cutter 100.

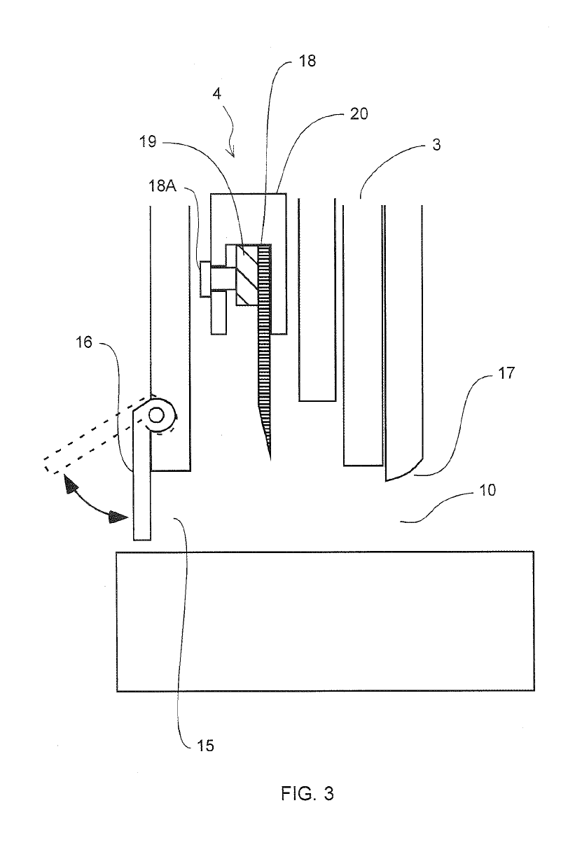

FIG. 3 shows a cross-sectional view of the blade assembly 4 and components around it.

As described above, the body case 3 has the insert opening 10 through which the objects are inserted into the body case 3. A tapered section 17 that is tapered toward the insert opening 10 is provided above the insert opening 10. The tapered section 17 serves to facilitate insertion of the object into the body case 3 through the insert opening 10. For example, when the advancing edges of the object are warped up, the tapered section 17 guides the warped edges of the object into the insert opening 10. The tapered section 17 can thus facilitate the insertion of the object into the insert opening 10.

An exit opening 15 is provided in the surface of the body case 3 opposite to the insert opening 10. The exit opening 15 is an opening through which the objects fed into the body case 3 through the insert opening 10 come out the body case 3. In the stack cutter 100 according to this embodiment, the object are cut in the body case 3 with their edges sticking out of the exit opening 15 after they are fed into the body case 3 through the insert opening 10 (i.e., the leading edges of the object are sticking out of the exit opening 15 and the opposite, trailing edges are sticking out of the insert opening 10.)

By way of example, a transparent protective cover 16 is suspended from the outer wall of the body case 3 above the exit opening 15. The protective cover 16 is hinged to the body case 3. It is pushed by the edges of the object and moves up in pivotal motion to open the exit opening 15 as depicted by the arrow when the object comes out. This protective cover 16 then moves down in pivotal motion under its own weight to cover the exit opening 15 as depicted by the arrow when the object in the exit opening 15 are removed. The protective cover 16 does not swing further into the body case 3, so no object such as stacked paper can be inserted through the exit opening 15 even if a user attempts to do so. The user can thus intuitively distinguish between the insert opening 10 and the exit opening 15. In addition, he or she is protected from nothing other than the object can also be inserted into the body case 3 through the exit opening 15, so that any accidental slip of a finger into the exit opening 15 can be prevented. This protective cover 16 is also one of the measures to increase the safety of the stack cutter 100.

The blade assembly 4 is configured with a blade 18, a reinforcing plate 19 bonded to the blade 18, and a frame 20 to which the combination of the blade 18 and the reinforcing plate 19 is fixed with a screw 18A. The frame 20 is a component to be mounted on the case 3 while the combination of the blade 18 and the reinforcing plate 19 are each removable from the case 3.

The reinforcing plate 19 is a rectangular plate having the same length as the blade 18 and is integrated with the blade 18 by being fixed to the upper end of the blade 18. The reinforcing plate 19 combines the function of reinforcing the blade 18 and the function of fixing the blade 18 to the frame 20.

The frame 20 is generally inverted U-shaped in cross section with the open end of the U facing downwardly. It is slightly longer than the blade 18. The structure made up of the blade 18 and the reinforcing plate 19 is fixed in the space inside the cross-sectionally generally U-shaped frame 20, with the upper surface of the structure contacting against the upper surface of the space in the cross-sectionally generally U shape. The frame 20 has a screw hole formed therein which is not shown. The screw hole has a threaded inner wall. The aforementioned screw 18A is threadedly engaged with the screw hole. By tightening the screw 18A, the tip of the screw 18A is abutted to the side surface of the aforementioned reinforcing plate 19 of the structure made up of the blade 18 and the reinforcing plate 19 after the screw 18A is advanced. The structure is thus sandwiched between and held by the screw 18A on one side of the space in the cross-sectionally generally U-shaped frame 20 and the inner surface of the space on the opposite side. In this way, the structure is fixed to the frame 20. On the other hand, when the screw 18A is loosened, the screw 18A is withdrawn and the fixture between the frame 20 and the structure is released.

As apparent from the above, the structure is designed to be able to be removed and attached from and to the frame 20. This is for allowing the user to replace the blade 18 (or the structure) that will wear out.

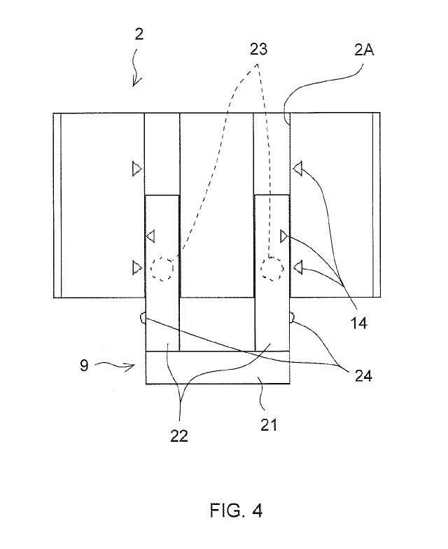

FIG. 4 shows a top plan view of the cutting base 2 and the guide member 9.

The guide member 9 has a pair of slider fingers 22 and a stopper 21. Each slider finger 22 is identical in cross section to a groove 2A having a rectangular cross section that is provided in the cutting base 2. The groove 2A has a length in the vertical direction from the perspective of FIG. 4. The slider fingers 22 can be moved vertically in the respective grooves 2A while being guided by the grooves 2A. The stopper 21 is connected to the bottom (from the perspective of FIG. 4) of the slider fingers 22 and extends from the slider fingers 22. The stopper 21 is for the user to set the side of the object against after he or she adjusts the placement of the slider fingers 22 appropriately in the lengthwise direction of the grooves 2A. With this, the user can place the object at a desired position. The upper surfaces of the slider fingers 22 are flush with the upper surface of the cutting base 2, so that the slider fingers 22 do not interfere with the positioning of the object.

Index marks 14 are provided at appropriate positions on the cutting base 2 and the guide member 9. The index marks 14 are provided at positions indicating the sizes of the object to be cut. The index marks 14 are provided for standard sizes (such as A4 and B5) of the object. The user can cut the object easily and precisely into any size such as one half of the object by cutting them after matching the edges of the object with the index marks. The user appropriately positions the guide member 9 relative to the cutting base 2 in such a manner that the index marks 14 on the guide member 9 and the cutting base 2 align with each other for expected size of the object that the user wants to cut. Merely by setting the side of the object against the stopper 21, the object can be positioned easily and precisely relative to the cutting base 2 or the cut position.

Magnets 23 are provided in the grooves 2A in the cutting base 2 at the positions corresponding to the aforementioned index marks 14. On the other hand, iron plates (not shown) that are attracted toward each magnet 23 by the magnetic force are embedded in the slider fingers 22 forming the guide member 9. The magnets 23 are positioned so that the plates are attracted toward the magnet 23 only at positions where the index marks 14 on the cutting base 2 and the guide member 9 align with each other. This provides automatic, precise and easy alignment between the index marks 14 on the guide member 9 and the cutting base 2 due to attraction of the plates toward the magnets 23 by roughly adjusting the relative position between the cutting base 2 and the guide member 9.

Furthermore, lugs or projections 24 are provided on the outer surface of each slider finger 22 of the guide member 9. The projection 24 is biased in the direction of the projection by a spring (not shown) provided in the guide member, but is withdrawn in the guide member 9 when an external force is applied. On the other hand, a bore is formed in the outer surface of each groove 2A of the cutting base 2 at the positions corresponding to the index marks 14 to receive the projection 24. When the user moves the slider fingers 22 of the guide member 9 in the lengthwise direction of the grooves 2A by gripping, for example, the stopper 21 of the guide member 9, the projections 24 latch into the bores giving “clicking” feeling to the user's hand through the guide member 9 only at the positions where the projections 24 latch into the bores. This clicking feeling is given only when the alignment is achieved between the index marks 14 on the guide member 9 and the cutting base 2. The user can use this clicking feeling to know whether the guide member 9 and the cutting base 2 are positioned correctly relative to each other using the index marks 14.

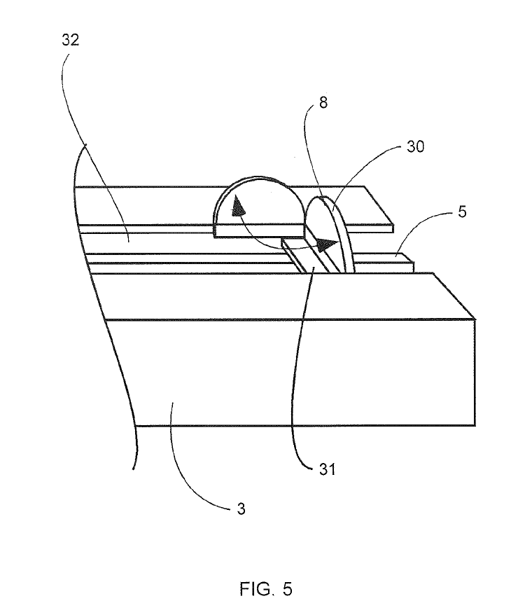

FIG. 5 is a perspective view showing the arm 5 housed in the body case 3 and locked with the locking member 8.

The locking member 8 is formed of, for example, a resin tab 30 and a metal, L-shaped arm keeper 31. The locking member 8 is provided on one side of the open end of an arm sheath opening 32 formed in the upper surface of the body case 3 in such a manner that the locking member 8 can turn as depicted by the arrows.

When the locking member 8 is turned over and across the arm 5, the arm 5 is prevented from moving up. As a result, the arm 5 housed in the body case 3 cannot escape from the body case 3.

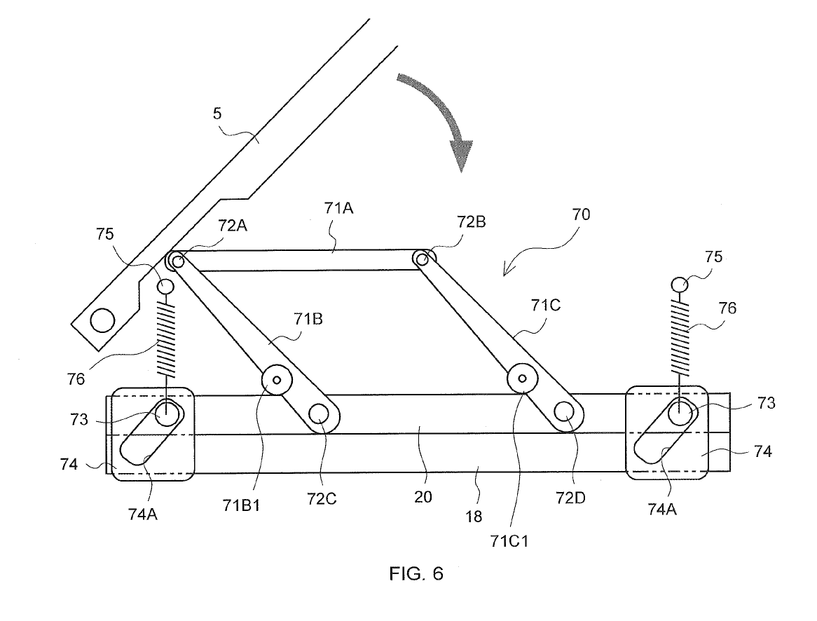

FIG. 6 is a schematic view of an example of a link mechanism 70 housed in the body case 3 of the stack cutter according to the present application. The link mechanism 70 is provided to transmit force from the arm 5 to the frame 20. The link mechanism 70 converts the swing motion of the arm 5 moved by the user into vertical movement of the blade 18 while keeping the edge of the blade 18 generally parallel to the upper surface of the object or the cutting base 2. The structure of the link mechanism is not limited to the one shown in FIG. 6 as long as the aforementioned conversion of the motion can be achieved.

The link mechanism 70 has a first link member 71A, a second link member 71B, and a third link member 71C, all of which have an elongated shape. The second link member 71B and the third link member 71C are equal in length to each other. Rollers 71B1 and 71C1 are attached to the second link member 71B and the third link member 71C, respectively, at positions near the lower ends thereof. The rollers 71B1 and 71C1 are sticking out toward the frame 20 and are rotatable about the shafts fixed to the second link member 71B and the third link member 71C, respectively.

One end of the first link member 71A is connected to the upper end of the second link member 71B by a first pivot joint 72A. The other end of the first link member 71A is connected to the upper end of the third link member 71C by a second pivot joint 72B. The first and second link members 71A and 71B are rotated about the pivot and relative to each other. The lower ends of the second link member 71B and the third link member 71C are connected to the frame 20 by third and fourth pivot joints 72C and 72D, respectively, so that the second and the third link members 71B and 71C are rotated about the pivot and relative to each other.

As a result, the first link member 71A, the second link member 71B, the third link member 71C, and a part of the frame 20 (a part of the frame 20 between the third pivot joint 72C and the fourth pivot joint 72D) forms a loop having a shape of a parallelogram with the first pivot joint 72A, the third pivot joint 72C, the second pivot joint 72B, and the fourth pivot joint 72D as vertices. This loop can be deformed by moving the first pivot joint 72A from the upper right to the lower left. In other words, the parallelogram loop can be flattened more as it moves toward the lower left from the shape illustrated in the figure and then raised as it moves toward the upper right. A spring (not shown) applies a biasing force to the loop that pushes the first pivot joint 72A to its original position where the first pivot joint 72A is located at an upper right to a certain degree.

Hollow cylindrical members 73 (which are not limited thereto) are provided on the frame 20. The hollow cylindrical members 73 are provided to engage guide members 74 to the frame 20. The guide member 74 is fixed to the body case 3 and has an oblique guide hole 74A. The hollow cylindrical member 73 is held within the guide hole 74A and can move along the length of the guide hole 74A. The direction of movement of the frame 20 is thus restricted to the direction along the length of the guide hole 74A.

The link mechanism 70 has fixture members 75. One end of the fixture member 75 is fixed to the body case 3 by predetermined means. The fixture member 75 is connected to the upper end of a lift-up spring 76 whose lower end is fixed to the hollow cylindrical member 73. The lift-up spring 76 is pressed and therefore an upper biasing force is always applied to the hollow cylindrical member 73 and, in turn, to the frame 20.

When the user moves down the arm 5, the arm 5 pushes the first pivot joint 72A downward. This deforms the aforementioned parallelogram loop as the first pivot joint 72A moves toward the lower left while keeping its parallelogram shape. The link receives a force to move the first pivot joint 72A toward the upper right by a spring which is not shown. The frame 20 receives a force to pull it upward by the lift-up spring 76. When the user normally moves the arm 5, the force applied by the arm 5 to the first pivot joint 72A overcomes these forces. The frame 20 to which the hollow cylindrical member 73 is fixed then moves toward the lower left as the hollow cylindrical member 73 moves along the guide hole 74A while being guided by it toward the lower portion of the guide hole 74A. In this way, the blade 18 cuts the object placed on the surface continued from the cutting base 2 in the body case 3.

When the frame 20 is moving downward, the rollers 71B1 and 71C1 of the second link member 71B and the third link member 71C, respectively, are abutted against the upper portion of the frame 20. In the second link member 71B, the first pivot joint 72A acts as the point of effort, the third pivot joint 72C acts as the fulcrum, and the contact point between the roller 71B1 and the frame 20 acts as the point of load. In the third link member 71C, the second pivot joint 72B acts as the point of effort, the fourth pivot joint 72D acts as the fulcrum, and the contact point between the roller 71C1 and the frame 20 acts as the point of load. The force moving the arm 5 downward is amplified and transmitted to the frame 20 through the principle of leverage both in the second and third link members 71B and 71C. This will allow the user to move the arm 5 with less effort.

After the cutting of the object is completed and the user returns the arm 5 to an upper position, the frame 20 returns to an upper position by the biasing force applied by the lift-up spring 76. The parallelogram loop returns to its original position by the biasing force applied by the spring (not shown) that acts to the first pivot joint 72A to return it to its initial position. The stack cutter is now ready to cut another stack of object.

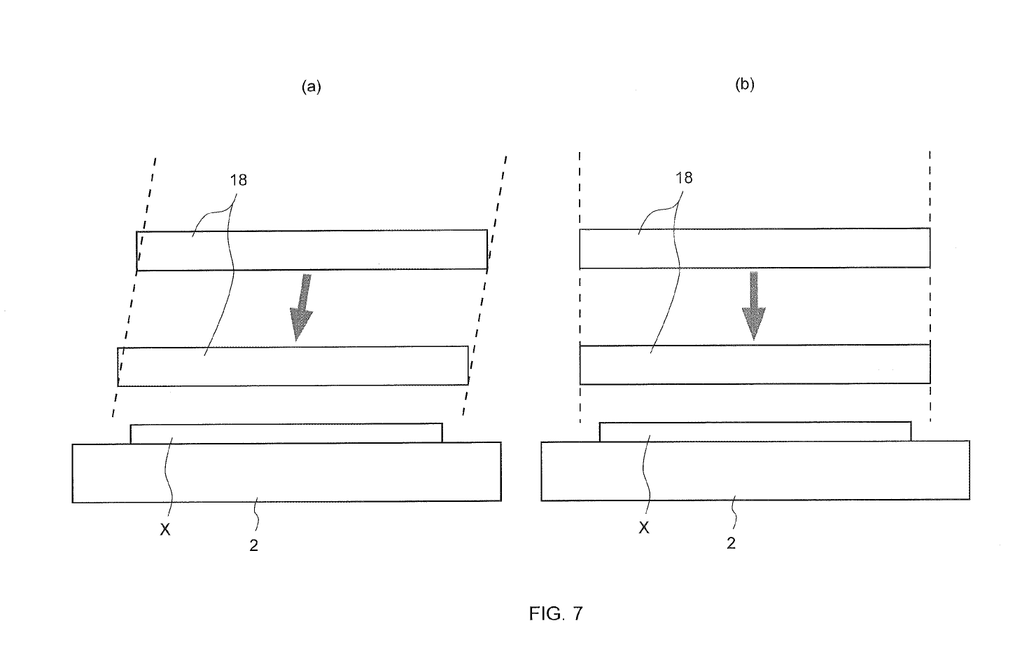

The blade 18 in this embodiment is brought down at a slight angle to the cutting base 2 while the edge of the blade is kept generally parallel to the upper surface of an object X, as shown in FIG. 7(a). However, another design may be used in which the blade 18 is brought down vertically while the edge of the blade is kept generally parallel to the upper surface of the object X, as shown in FIG. 7(b). Such a modification can easily be achieved by appropriate modifications of the link mechanism. As used herein in connection with the orientation of the edge of the blade, the term “generally parallel to the upper surface of the object X” includes cases where the edge of the blade is not exactly parallel to the upper surface of the object X (e.g., the edge of the blade makes an angle of 5 degrees or smaller) and where the angle changes as the blade 18 moves.

The blade 18 of this stack cutter is thin in contrast to conventional stack cutters that use a thick cutting blade. The use of such a thin cutting blade in combination with the reinforcing plate results in cost reduction.

In particular, replacement blade assemblies can be provided at lower cost and easier replacement can be achieved.

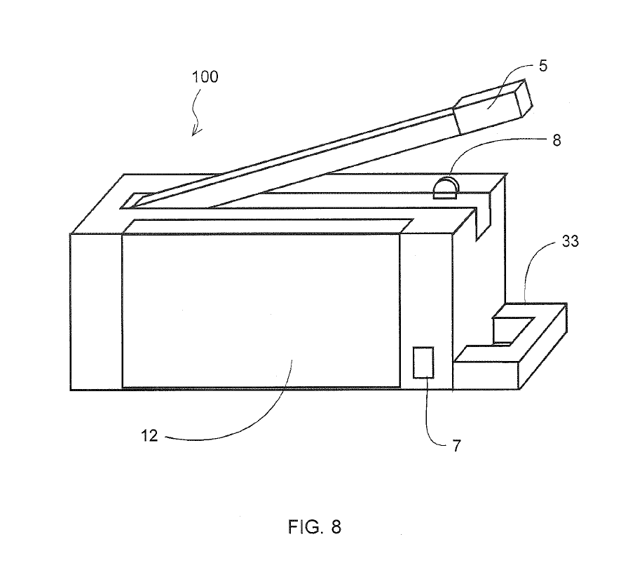

FIG. 8 shows a perspective view of a modified version of the stack cutter according to this embodiment. This stack cutter has a handle 33 attached to the body case 3 for easier carrying of it.

The handle 33 improves the convenience of the stack cutter.

It should be noted that this stack cutter may be stored in a smaller space in portrait orientation with the handle 33 facing upward, instead of in landscape orientation as shown in FIG. 8 when, for example, the stack cutter is not going to be used for a long time.

The present invention is not limited to these described in conjunction with the aforementioned embodiment. For example, the structure and the shape of the components including the body case and the cutting base may be change in various ways. In addition, the structure to house and fix the cutting base in the body case, the shape of the guide member, and the structure of the locking member are not limited to those described in conjunction with the aforementioned embodiment.

1. A stack cutter comprising:
a body case having an insert opening formed in one end of the body case through which an object to be cut is inserted into the body case, and an exit opening formed in the other end of the body case through which the object comes out, the body case comprising a cutting portion with a mounting surface on which the object is cut, with its leading edge sticking out of the exit opening and its trailing edge being left without being inserted into the body case;
a blade adapted to move vertically relative to the mounting surface provided on the body case to cut the object; operating means for use in moving the blade up and down; and
a cutting base surface that can be flushed with the mounting surface,
the cutting base being designed to be in a first position in which the cutting base surface is flush with the mounting surface and a second position in which the cutting base is folded against the body case in such a manner that the cutting base covers the insert opening.

2. The stack cutter according to claim 1, wherein the cutting base is housed in the body case when it is in the second position.

3. The stack cutter according to claim 1, further comprising:
a light emitting unit that projects a linear light beam onto the cutting portion to allow a user to visually confirm a cut line identifying the cut position on the object placed on the cutting portion,
the light emitting unit being controlled to be turned off when the cutting base comes to the second position.

4. The stack cutter according to claim 1, wherein a protective cover is provided over on, or in the exit opening to close the exit opening, the protective cover being designed to open the exit opening by the object inserted through the insert opening,
the protective cover being designed not to open the exit opening when a user attempts to insert the object through the exit opening.

5. The stack cutter according to claim 1, wherein a tapered section is provided above the insert opening, the tapered section being tapered inwardly toward the insert opening.

6. The stack cutter according to claim 1, wherein a guide member is provided on the cutting base, the guide member being able to be positioned relative to the body case when the cutting base is in the first position, the guide member being used to set the side of the object against to position the object.

7. The stack cutter according to claim 1, wherein the operating means is a stick-shaped arm, and the body case is configured to house the arm,
the body case having an arm locking member to fix the arm when the arm is housed in the body case.
